(19) United States
(12) Patent Application Publication
(10) Pub. No.: US 2009/0109404 A1
(43) Pub. Date: Apr. 30, 2009

(54) PROJECTION SYSTEM FOR AERIAL DISPLAY OF THREE-DIMENSIONAL VIDEO IMAGES

(75) Inventor: CURTIS L. THORNTON, Simi Valley, CA (US)

Correspondence Address: J C PATENTS, INC., 4 VENTURE, SUITE 250, IRVINE, CA, 92618, US

(73) Assignee: PROVISION INTERACTIVE TECHNOLOGIES, INC, CHATSWORTH, CA (US)

(21) Appl. No.: 12/259,013

(22) Filed: Oct. 27, 2008

Related U.S. Application Data
(60) Provisional application No. 60/984,340, filed on Oct. 31, 2007.

(51) Int. Cl. G03B 21/00

(52) U.S. Cl. 353/10

(57) ABSTRACT

An aerial image projection device capable of generating an aerial image projection that is a combination of two-dimensional and/or three-dimensional video images includes a housing containing the following: a first and a second video display device, a beam splitter, a spherical mirror and a polarizer. The first and the second video display devices, the beam splitter, the spherical mirror and the polarizer are optically aligned so that video images generated by the first and the second video display devices are projected by the spherical mirror as the aerial image projection. The first and the second video display devices include high bright superblack liquid crystal displays, and a polarizer is optically aligned so that images of a viewer are not reflected by and thereby projected from the spherical mirror.

### CROSS-REFERENCE TO RELATED APPLICATION

This application claims the priority benefit of U.S.A. provisional application Ser. No. 60/984,340, filed on Oct. 31, 2007. The entirety of the above-mentioned patent application is hereby incorporated by reference herein and made a part of this specification.

### BACKGROUND OF THE INVENTION

1. Field of the Invention

The present invention relates to an aerial image projection system for the display of aerial image projections.

Aerial image projection systems are known in the art. Such systems utilize a plurality of optical elements such as mirrors, Fresnel lens and optical filters or polarizers to project images of objects into space. The optical elements and the object are positioned in a housing to define an optical path. Depending on arrangement and selection of the optical elements, the aerial image projection is visible either within the dimensions of the housing or a short distance in front of the housing. Examples of aerial image projection systems include U.S. Pat. No. 5,311,357, U.S. Pat. No. 5,552,934, U.S. Pat. No. 4,802,750, and U.S. Pat. Design 435,043.

Prior art aerial image projection systems are expensive because of cost of optical elements required to project the images of the objects. More specifically, the prior art aerial image systems use one or more spherical glass mirrors in the optical path together with one or more glass polarizers maintained in a fixed orientation with respect to a stage where the object is positioned. Unfortunately, a 15-inch spherical glass mirror costs well over $1,000 and a polarizer costs about $850. Clearly, the spherical glass mirrors and the polarizers are major contributors to the high cost of the prior art aerial image projection systems. Not only expensive, the spherical mirrors and the polarizers are also very heavy so adequate support must be provided. Accordingly, a heavy box-like housing is used to maintain the orientation of the optical elements with respect to the object. Unfortunately, transporting the housing from one location to another is difficult and expensive. What is needed is an aerial image projection system that is lightweight, inexpensive and easily transportable from one location to another.

While the prior art aerial image projection systems generate visually captivating aerial image projections, there are a number of problems that limit use of aerial image projection systems in a wide variety of applications. Accordingly, the prior art aerial image projection systems are typically used in museums or retail stores to display expensive items where objects being displayed can be kept safely out of reach of observers.

The prior art aerial image projection systems typically use three-dimensional objects as the sources of the images. For example, a small statue may be placed on a pedestal and brightly lighted with spotlights. A three-dimensional image of the statue is projected through a display window and viewed by observers who are positioned in front of the display window as if the statue were floating in air.

A problem with using the objects as the sources of the images is difficulty and expense associated with changing the images. Thus, to maintain interests of the viewers and to preserve novelty of the aerial images, the objects must be constantly changed. This is a labor-intensive process as an attendant must open a door in the housing, remove the object, position a new object and verify that it is properly positioned on the display pedestal.

To overcome this limitation, aerial image projection systems have attempted to utilize video display devices instead of the physical object as the sources of the images. Unfortunately, video images appear together with images of the video display device. Thus, rather than displaying aerial image projections, the video images appear to the observers as a floating video display device thereby rendering an illusion of the video images floating in air ineffective. What is needed is an aerial image projection system capable of displaying video images without the video display device being visible to the observers.

Another problem associated with projections of video images arises from the video display device itself. Specifically, a video display device uses a flat piece glass behind which the video images are generated. The flat piece of glass tends to reflect external images that pass through the optical elements in the optical path. The reflected external image is viewable by the observers resulting in a noticeable double aerial image projection. Clearly, what is needed is an aerial image projection system that eliminates reflected images from the aerial image projections.

Yet another problem with prior art projection of video images arises when the object moves off screen. More specifically, when a video image transgresses beyond a boundary of the video display device, the observer immediately detects the boundary and the illusion of the floating image is lost. Accordingly, what is needed is a method for projection of a video image in a manner that does not suggest that the video image is generated by a video display.

Thus, a better system and a method for projecting aerial image projections are needed. More specifically, what is needed is an aerial image projection system for projecting video images at video rates that is lightweight and inexpensive.

### SUMMARY OF THE INVENTION

The present invention relates to an aerial image projection system and a method. More specifically, the present invention relates to an aerial image projection system having a housing for positioning low cost optical elements capable of generating an aerial image projection that is a combination of two-dimensional and three-dimensional video images, projected inside or outside the dimensions of the housing, and visible to an observer in ambient light conditions. The aerial image projection system is capable of displaying the aerial image projection at video rates without reflected artifacts or visible display of the video display device. A method incorporates a set of rules to eliminate boundary transgressions and to maximize an illusion of the aerial image projection.

According to an embodiment, the aerial image projection system of the present invention comprises a plastic spherical mirror disposed in the housing. A planar plastic beam splitter is positioned in front of the spherical mirror. The beam splitter is preferably oriented at a forty-five degree angle relative to a face of the mirror. To minimize glare and reflections, a polarizer is disposed on the housing in optical alignment to the beam splitter, or the polarizer is combined in one part with the beam splitter.

A first video display device comprising a high bright liquid crystal display (HLCD) device is positioned proximate to the beam splitter, so that video images on the first video display device is projected by the beam splitter onto the spherical mirror and then out through the polarizer. A second video display device and a planar mirror are positioned in optical alignment to the beam splitter, so that video images on the second video display device are reflected by the planar mirror and subsequently projected by the beam splitter onto the spherical mirror and then out through the polarizer. The first and the second video display devices have a 20 degree viewing angle to reduce light loss, heat generation and power consumption and allow for brighter video images. In addition, angles between the polarizer and the first and the second video display devices are adjusted to reduce light loss when light passes through the polarizer. A computer system, coupled to the first and the second video display devices, provides a source of video images for display at video rates. The computer system drives a single video display device or a plurality of video display devices and runs an application that plays two different video images at the same time. Novel features of the video display devices and a method for presenting video images eliminate projection of observable boundaries. The video images displayed on the video display devices comply with a set of display rules so that the observer is not presented with display incongruities that would ruin the illusion of the aerial image projections. Specifically, the display rules limit movements of the video images beyond edges or boundaries of the video display devices and limit background colors that would cause the edges of the video display devices to be come visible. Accordingly, the movements of video images are in accordance with selected techniques. In addition, the video images are generated in a way to create interaction in between. The video images may transform from being two-dimensional to three-dimensional or vice versa. The video images may also be synchronized together or displayed at random.

Furthermore, there is video data sharing. For example, a first video image on the first video display device may supply video information to a second video image on the second video display device, the second video image may jump from a position inside the second video display device to a position outside the first video display device displaying the first video image, or the first video image may present a character that appears in the second video image.

The video data sharing is achieved through a data file that is associated with each of the video images. The data file is read before the video images are displayed to determine a course of action. The data file may cause the video images to move from a video display device to another video display device, to be displayed on a video display device and then on another video display device, to move in synchronization with other video images, to stop at a predetermined time, or to search for a new video images to be displayed based on a preset condition.

According to another embodiment, the computer system is coupled to a communication network so a sequence of video images is transferred to the computer system from a remote location for display. The communication network enables the observer to request additional information or to select display of a different sequence of video images.

According to still another embodiment, a third video display device is disposed at a portal of the aerial image projection system. The third video display device is preferably a transparent imaging panel that is used as a background display device for displaying video images of video rate that are not projected aerial images. Thus, the observer is presented a rich and varied display environment where the background display device is combined with the aerial image projections. With the three video display devices, the observer is actively engaged in viewing a dynamic, realistic video event.

The present invention further comprises a method for generating and displaying an aerial image projection that is a combination of two-dimensional and three-dimensional video images using the above aerial image projection system. The method comprises using a set of software development tools for crafting and positioning two-dimensional or three-dimensional video images on the video display devices so that the observer perceives the aerial image projections floating in space without detecting the boundaries of the video display devices. The software development tools further include logic for developing a sequence of video images of video rate.

The important advantages of the present invention will become apparent as description that follows is read in conjunction with accompanying drawings.

### DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block view showing an aerial image projection system according to an embodiment of the present invention.

FIG. 2 is a sectional side view showing an aerial image projection system according to an embodiment of the present invention.

FIG. 3 is a schematic view showing a video display device comprising an HLCD of FIG. 2.

FIG. 4 is a block view showing an interface and an associated video display device of a digital controller according to an embodiment of the present invention.

FIG. 5 is a view showing a lightweight modular housing of the aerial image projection system of the present invention.

FIG. 6 is a top view of a composite plastic spherical mirror of the present invention.

FIG. 7 is a front view of the composite plastic spherical mirror illustrated in FIG. 6.

### DESCRIPTION OF EMBODIMENTS

In the following description according to an embodiment, reference is made to accompanying drawings, which form a part hereof, in which is shown by way of illustration specific embodiment in which the invention may be practiced. In the following description, numerous specific details are set forth in order to provide a complete understanding of the present invention. It will be apparent to one skilled in the art that the present invention may be practiced without the specific details. In the development of the actual implementation, numerous implementation-specific decisions must be made to achieve the design goals that will vary for each implementation. Accordingly, in order not to obscure the present invention, well-known structures and techniques are not shown or discussed in detail.

The present invention relates to an aerial image projection system for displaying an aerial image projection that is a combination of two-dimensional and/or three-dimensional video images and a method thereof. More particularly, the present invention relates to an improved system for displaying an aerial image projection that is a combination of two-dimensional and three-dimensional images without a visible image of the video display devices and a method thereof.

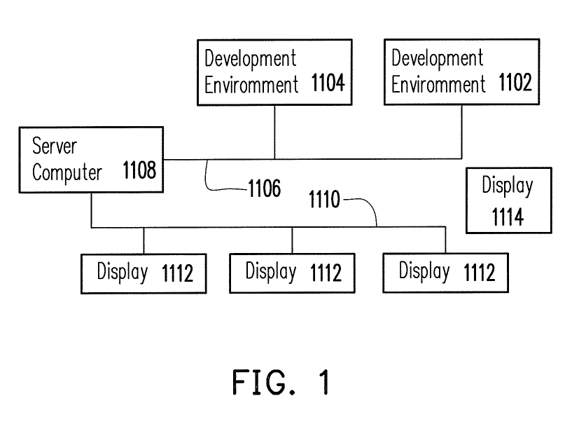

Please refer to FIG. 1, which is a block view showing an aerial image projection system according to an embodiment of the present invention. A client environment 1102 represents an advertiser or business entity that wishes to convey information or entertainment using aerial image projections of video images. According to the present embodiment, the client environment 1102 comprises a computer-based development system where sequences of the video images are generated for display. The video images are typically animations because they are easier for manipulation although three-dimensional video images generated by various camera technologies may be readily adapted for display. The video images may be displayed in conjunction with a sound track so the client environment 1102 may include a sub system for sound recording and digitization (not shown).

When finalized, the video images are transferred from the client environment 102 to a development environment 1104 to ensure compliance with display rules. Accordingly, movement of the video images is compared to the display rules to verify that an aerial image projection appears. A communication network 1106 is used to transfer the video images from the client environment 1102 to the development environment 1104. The communication network 1106 may be the Internet, telephone or wireless networks or a local area network (LAN) well known in the art of computer networking.

When the video images are certified, they are transferred to a server computer 1108. The server computer 1108 has video image storage and means for driving one or more aerial image projection devices 1112 over another communication network 1110. The communication network 1110 may be an Ethernet or Internet Protocol (IP) LAN or the Internet. The communication networks 1110 and 1106 may be considered a single IP based network such as the World Wide Web (WWW).

Referring to FIG. 1, three such aerial image projection devices 1112 are shown but it is to be understood that actual number of the aerial image projection devices 1112 will depend on capability of the server computer 1108 to manage multiple streams of data of the video images. Accordingly, the server computer 1108 may be coupled to a single aerial image projection device 1112 or to a plurality of aerial image projection devices 1112 greater than illustrated.

One advantage of the server computer 1108 arises from tracking response of the observer to a particular sequence of the aerial image projections. Accordingly, a mouse or motion detector (not shown) may be positioned proximate to the aerial image projections to detect feedback from the observer. When the observer responds, this information is transmitted back to the server computer 1108 for statistical analysis or response. In response to input from the observer, the sequence of the aerial image projections may be altered by selecting one of a plurality of sequences of the aerial image projections either at levels of the server computer 108 or the aerial image projection devices 1112.

The sever computer 1108 may store the video images in compressed format in which case either the server computer 1108 or a computer system associated with each of the aerial image projection devices 1112 must decompress the video images prior to display. An additional aerial image projection device 1114 functions in a stand-alone manner and may receive the video images from either the development environment 1104 or from the server computer 1108 over a temporary connection to network 1106. Alternatively, the aerial image projection device 1114 may be loaded with a dedicated sequence of video images and operates without connection to either the communication networks 1106 or 1110. The video images may be transferred to the aerial image projection device 1114 through a storage device such as a DVD or a CD optical disk.

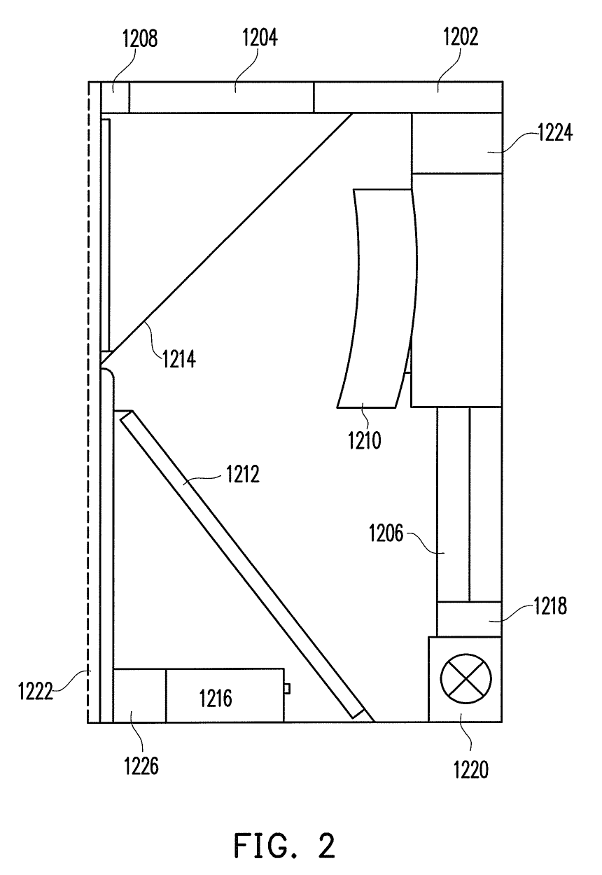

FIG. 2 is a sectional side view showing an aerial image projection device 1200 that may be used as either the aerial image projection device 1112 or the aerial image projection device 1114 according to an embodiment of the present invention. Regardless of environmental configuration, the aerial image projection device 1200 incorporates a first video display device 1204 and a second video display device 1206 positioned in a housing 1202. The housing 1202 provides a support frame for maintaining optical elements in a fixed orientation relative to the video display devices 1204 and 1206. The optical elements comprise a polarizer 1208, a spherical mirror 1210, a planar mirror 1212, and a beam splitter 1214 positioned between the spherical mirror 1210 and the polarizer 1208. The beam splitter 1214, the spherical mirror 1210 and the polarizer 1208 are preferably optically aligned in a first portion of the housing 1202 so that images formed on the first video display device 1204 are projected outward toward the observer. The polarizer 1208 may also be combined in one part with the beam splitter 1214. The planar mirror 1212, the beam splitter 1214, the spherical mirror 1210 and the polarizer 1208, are optically aligned in a second portion of the housing 1202 so that images formed on the second video display device 1206 are projected outward toward the observer.

The polarizer 1208 minimizes reflections and glare that may be visible to the observer. The polarizer 1208 may be either a linear polarizer or preferably a circular polarizer.

In addition, angles between the polarizer 1208 and the first video display device 1204 and the second video display device 1206 are adjusted to reduce light loss when light passes through the polarizer.

According to an embodiment of the present invention, the polarizer 1208 is a film polarizer, so that weight associated with glass substrates of the prior art polarizers are eliminated thereby resulting in lower weight of the aerial image projection device 1200.

Spherical mirrors are well known in the art and typically comprise glass substrates having a concave surface with evaporated aluminum applied as reflective surfaces. The glass substrates are typically preferred in prior art aerial image projection systems because of a belief that sphericity tolerance must be maintained to at least ±0.05% from an edge to the other edge to minimize distortion and to ensure realistic reproduction of an object. Unfortunately, such mirrors are heavy and expensive and have limited commercial applications. Accordingly, in the present invention, both the spherical mirror 1210 and the planar mirror 1212 are preferably lightweight and inexpensive. For this reason plastic mirrors are preferred. With the lightweight plastic spherical mirror 1210 and the lightweight plastic planar mirror 1212, coupling the spherical mirror 1210 and the planar mirror 1212 to the housing 1202 is simplified. According to an embodiment of the present invention, a 10×15 inch plastic spherical mirror with an 18-inch spherical radius is adequate for a wide variety of applications. Such applications include retail applications for display of product advertisements, business applications for videoconferencing or sales presentations or home applications replacing a standard computer display or a television set.

Beam splitters are also well known in the art and typically comprise a partially silvered glass plate. As noted above, glass is both heavy and expensive. Accordingly, the beam splitter 1214 preferably comprises a partially silvered plastic plate and, more specifically, a sheet of partially silvered acrylic plastic or plexiglass, both of which are lightweight and inexpensive with optical qualities comparable to that of glass. The beam splitter 1214 should be larger than both the spherical mirror 1210 and the planar mirror 1212. According to an embodiment, the beam splitter is approximately 12×16 inches.

In a second portion of the housing 1202, the second video display device 1206 is oriented so that displayed video images are projected toward the beam splitter 1214 through the planar mirror 1212. A computer 1216 is shown inside the housing 1202. The computer 1216 controls the first and the second video display devices 1204 and 1206 in response to video image files transferred to the computer 1216 from either the server computer 1108 or from a CD-ROM disk. If the aerial image projection device 1200 is provided without a local computer, images displayed on the first and the second video display devices 1204 and 1206 are transferred directly from the server computer 1108.

To prevent reflected images entering the aerial image projection device 1200 from being propagated throughout the optical path, surfaces of the first and the second video display devices 1204 and 1206 facing the beam splitter 1214 may be coated with anti-reflective coating. Without the anti-reflective coating, the observer could, under certain viewing conditions, view their own image or a double image created by a reflection of the aerial image projection due to an optical mis-match between the optical elements and the first and the second video display devices 1204 and 1206.

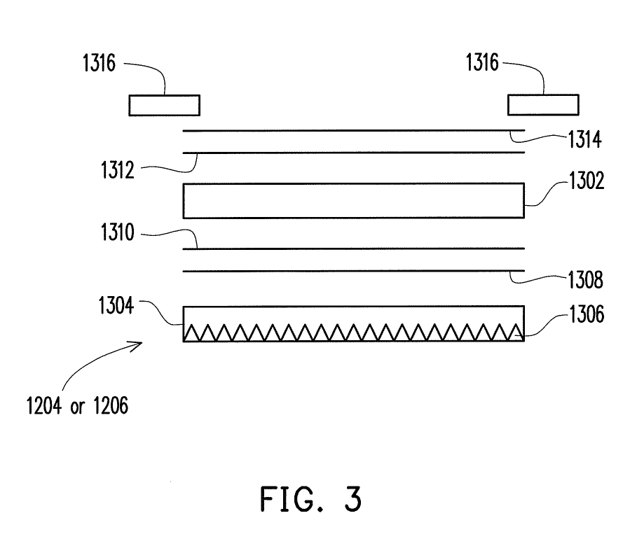

Referring now to FIG. 3, the first and the second video display devices 1204 and 1206 are illustrated in detail. According to an embodiment of the present invention, each of the video display devices comprises a liquid crystal display (LCD) panel 1302. To obtain true video rates, the LCD panel 136 is based on thin film transistor (TFT) HLCD panel technology. The transistors are controlled to transmit selective frequencies of light. Typically, three thin film transistors define a pixel, one to control a green component, one to control a red component and one to control a blue component. TFT LCD panel technology is well known in the art and will not be further explained. The LCD panel 1302 is referred to as a high bright dark field panel that incorporates a bright (high lumens or NITS) backlight but maintains a true black even at high levels of illumination. It will be appreciated that with standard commercial LCD panels, the bright backlight will cause a small amount of light to pass between pixels resulting in a gray appearance rather than the true black. Thus, with the prior art TFT HLCD panels, high intensity light tends to ‘wash-out’ black and other dark colors resulting in a black-gray color that the observer may readily detect. More specifically, with the black-gray color, edges of LCD panel 1302 are readily discernable to the observer of the aerial image projection. Accordingly, the LCD panel 1302 is a dark field panel. The phrase ‘dark field’ means that there is low transmissivity between pixels of the LCD panel 1302. Low transmissivity means that uncontrollable light transmission is effectively eliminated from regions of the LCD panel 1302 between each of the adjacent pixels. A black out grid, printed around the pixels, is an example of a mechanical means for limiting the light transmission from regions between the pixels. In addition, the LCD panel 1302 has a 20 degree viewing angle to reduce light loss, heat generation and power consumption and allow for brighter video images.

To obtain a brightness required for projecting vivid aerial image projections, a full spectrum backlight 1304 is used as a light source for illumination. The full spectrum backlight 1304 has an intensity increased from a typical 900 NITS to at least 3,600 NITS (Lumens). A prism 1306 reflects off-axis light back through the LCD panel 1302. Birefringence filters 1308 and 1310 remove high frequency components and orient the light before it reaches the LCD panel 1302. A primary consideration when displaying video images is that the backlight 1304 retains sufficient intensity to project the aerial image projections even as efficiency of the backlight 1304 decreases over time. Accordingly, the intensity of the backlight 1304 is initially set to a level less than maximum. For example, the intensity is set to between 50% and 80% of maximum intensity and preferably to about 75%. Over time, as the efficiency of the backlight 1304 degrades, the intensity of the backlight 1304 may be increased to compensate for degradation.

As is well understood in the art of computers, by controlling a state of the pixels on the LCD panel 1302, selective frequencies of light are passed to form an image on the screen. Thereafter, the light passes through a light collimating filter 1312 and a polarizer 1314, which may be a linear polarizer. The polarizer 1314 comprises a layer of anti-reflective coating on a surface oriented away from the LCD panel 1302. The coating minimizes reflected light that could be retransmitted through the optical elements and is an especially important feature if the polarizer 1208, referring to FIG. 2, is eliminated.

It will be appreciated that common video display devices configured for use in ambient light conditions have insufficient brightness to achieve a vivid aerial image projection of the displayed video images. Simply increasing the brightness is an unacceptable alternative because raster scan becomes visible thereby rendering the illusion of the aerial image projection ineffective. Plasma display panels, while bright, are too expensive for most commercial applications. Field emissive displays (FEDS) are also too expensive and are not sufficiently bright enough. Further, a commercial LCD device typically provides a wide field of view. However, in the present invention, the first and the second video display devices 1204 and 1206 preferably have narrow fields of view to reduce disbursement of off-axis light and focus high percentages of light in a forward direction toward the observer. Accordingly, the first and the second video display devices 1204 and 1206 are the preferred platforms for generating bright images on a black background. The aerial image projection device 1200 of the present invention projects the vivid aerial image projection where the observer cannot perceive an outline of the LCD panel 1302 even with increase in the brightness of the backlight 1304. In the present invention, the aerial image projection is further improved by use of the LCD panel 1302 in combination with optical filters, polarizers and anti-reflective coatings.

Referring again to FIG. 2, the housing 1202 includes a thermal control switch 1218 to maintain operating ambient temperatures inside the housing 1202 below at least 100 degrees Fahrenheit and preferably to about 85 degrees Fahrenheit. To achieve this environment, a plurality of fans 1220 is coupled to the thermal control switch 1218. The fans create air movement in the second portion of the housing 1202 and particularly around the second video display device 1206 to minimize ambient heating associated with the backlight 1304.

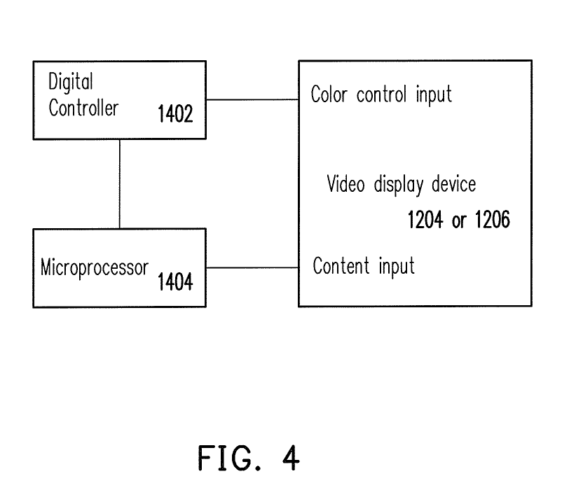

Referring now to FIG. 4, wherein a block view showing an interface and an associated video display device of a digital controller is shown according to an embodiment of the present invention. According to the present embodiment, a digital controller 1402 interfaces with either the sever computer 1108 or the computer 1216 to receive display information. By using the display information, the digital controller 1402 controls the pixels of the LCD panel 1302. The pixels that are not a part of the displayed image (inactive pixels) are set to super-black. The digital controller 1402 is responsible for ensuring that the inactive pixels are not partially transmissive by providing a digital signal corresponding to super-black. Super-black, by way of example, is defined as follows: where there are 256 shades of gray between black and white, super-black comprises the darkest twenty shades (approximately the darkest 8%) and preferably the darkest five shades (approximately the darkest 2%). The digital controller 1402 is adjusted so that the lowest output level (zero red, zero green and zero blue) corresponds to the darkest achievable state. The digital controller 1402 interfaces with a dedicated microprocessor 1404 that drives the video display devices 1204 and 1206. For the pixels to achieve true black, the digital controller 1402 must control gray scale so that the minimum output of the digital controller 1402 corresponds to the darkest state of the first and the second video display devices 1204 and 1206.

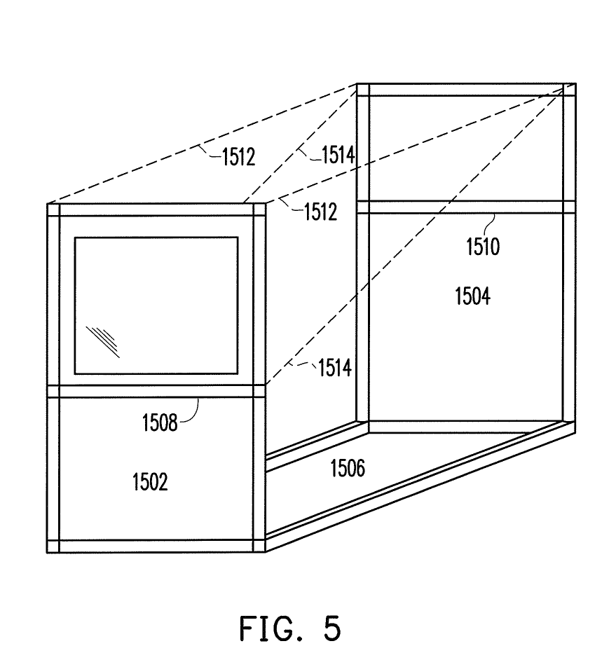

FIG. 5 is a view showing the lightweight modular housing 1202 of the aerial image projection device of the present invention. According to an embodiment of the present invention, the housing 1202 comprises a lightweight aluminum frame having a front panel 1502, a rear panel 1504 and a base panel 1506. The lightweight aluminum frame may be hinged so that the front panel 1502 and the rear panel 1504 fold down onto the base panel 1506 to minimize space needed to transport or store the housing 1202. Alternatively, the lightweight aluminum frame may comprise a front, a rear and a base portion that employ a peg and socket technique to maintain the front, the rear and the base panels 1502, 1504 and 1506 in proper orientation. Thus, when traveling, the front, the rear and the base panels 1502, 1504 and 1506 are separated and stacked so that they may be readily boxed or carried.

Each of the front panel 1502 and the rear panel 1504 comprises a sheet of lightweight opaque plastic. Preferably, the lightweight opaque plastic is black. Exterior sides of the sheets may have printed graphics or ornamental designs attached. Thus, the housing 1202 may be quickly adapted to match the intended use of the aerial image projection system. For example, the exterior may be printed with a company's logo to draw attention of observers in the vicinity to view an animation or a company's icon may be attached to the housing.

The front, the rear and the base panels 1502, 1504 and 1506 are generally rectangular walls although other shapes may be readily envisioned. Cross members 1508 and 1510 provide rigidity to the housing 1202 and are used for mounting the optical elements illustrated in FIG. 2. Rods or other rigid members, represented by dashed lines 1512 are used to couple a top of the front panel 1502 to the rear panel 1504. Diagonal support rods, illustrated by dashed lines 1514, are used to support and position the beam splitter 1214 in front of the spherical mirror 1210. The support rods 1514 extend from the cross member 1508 to a top of the rear panel 1504. The manner of connecting the support rods 1514 to the cross member 1508 and the rear panel 1504 is not critical so long as connection is stable and able to support weight of the beam splitter 1214.

A top panel, which may be a rigid plastic sheet (not shown) is positioned over the rods 1512 and secured to a top of the front and the rear panels 1502 and 1504, respectively. Side panels (not shown), which again may be rigid plastic sheets, are secured to the base panel 1506 and the front and the rear panels 1502 and 1504, respectively. The front and the rear panels 1502 and 1504 panels may fit into a groove provided on an inside portion of the base panel 1506, the front panel 1502 and the rear panel 1504 so as to provide an aesthetically pleasing “tongue and groove” appearance. The tongue and groove method for attaching the front, the rear and the base panels 1502, 1504 and 1506 to the frame ensures a dark interior by eliminating any gaps through which ambient light may pass. Further, the tongue and groove method eliminates the need to transport or store a separate mechanism, such as screws or tape, for attaching the facade to the frame. An interior blackout curtain (not shown) or other optical blocks may be positioned along the joints between panels to minimize entry of the ambient light. The selection of the housing design may vary depending on the specific application and is typically an engineering or marketing selection.

The housing 1202 is lightweight and capable of being readily transported or stored. Because the housing 1202 is also inexpensive, multiple housings may be used in an interchangeable manner while sharing the optical elements. Thus, it is possible to rapidly change the exterior appearance of the housing 1202 to fit intended application or to transfer the optical elements to another housing so that a user need not wait to change from one task to another.

Referring to both FIGS. 2 and 5, the housing 1202 may include an optional transparent imaging panel 1222 that attaches to the top of front panel 1502. The transparent imaging panel 1222 is independently controlled to generate a displayed video image that is separate from the aerial image projection. Importantly, because the transparent imaging panel 1222 is normally transparent, the display of the aerial image projection is not affected. However, the transparent imaging panel 1222 may be controlled to act as a light curtain, or a light valve. When the aerial image projection is projected, the transparent imaging panel 1222 is changed to transparent so that the aerial image projection is observable. Importantly, portions of the transparent imaging panel 1222 may be selectively controlled to provide a full color background for the aerial image projection. A preferred transparent imaging panel is commercially available from ProVision Entertainment, the assignee of the present invention, under the trademark of T.I.M.™.

In order to generate video images (video content) for display, a software application product provided by Provision Entertainment, the assignee of the present application, converts digitized video images to a display format compatible with the aerial image projection device 1200. The digitized video images must be consistent with a set of display rules to ensure the aerial image projection appears as the combination of two-dimensional and/or three-dimensional video images. By way of example, the video content is not allowed to move off edges of the video display devices because the video content must always remain on screen to avoid having the observer detect edges of the video display devices. Additional rules include: 1) converting the background to a super-black state to achieve high contrast with the aerial image projection; 2) using effective color schemes that incorporate red and yellow colors and de-emphasize blue and green colors which do not project well; and 3) removing video images from the video content if they do not project well. The surface appearance of an object is important to provide and maintain the illusion of a combination of two-dimensional and/or three-dimensional video images. Selecting the proper color scheme will sharpen three-dimensional effects and give the observer a sense of depth and volume.

In addition, the video images are generated in a way to create interaction in between. The video images may transform from being two-dimensional to three-dimensional or vice versa. The video images may also be synchronized together or displayed at random.

According to an embodiment of the present invention, popular digital image tools are used to create displayable video images that are then placed in a computer file associated with the microprocessor 1404. When the computer file is to be displayed, the microprocessor 1404 controls the digital controller 1402 and the first and the second video display devices 1204 and 1206 to generate the aerial image projection. The microprocessor 1404 plays the video content as a series of still video images to achieve an appearance of motion. The microprocessor 1404 utilizes a commercially available DIVx MPEG-4 Video Codec V3.22 to support a screen resolution of 800×600 pixels, 10 frames per second, a 90 smoothness-crisp and a 6000 bits per second data transfer rate from the microprocessor 1404 to the first and the second video display devices 1204 and 1206. Although the quality of the displayed video images with the 6000 bpi date transfer is satisfactory for most applications, it is possible that the play of the video images may be interrupted or if the microprocessor 1404 is multitasking or has a large number of applications running in background. For animated video images, it is desirable to minimize rapid or quick movement to correspond to a 3000 bpi data rate. Accordingly, the set of display rules includes the limitation to minimize image movement to a rate that is no more than one half of the maximum transfer rate.

The set of design rules further include a technique for effectively presenting the animated video images to the observer. Specifically, materialization of the video images from behind a foggy background is an effective manner to present the video images. Materialization is also used when rapid shape variation of the video images occurs during a rotational motion. When a picture is not stable but rather dithered at a slow rate, the holographic effect is further enhanced. The video images are removed from view by dissolving the video images in conjunction with generation of a strobe light image.

Display of a human face, head or full body of a model in real-time is possible by positioning a model in front of a dark, preferably black background. Multiple cameras are positioned around the subject to obtain multiple perspective views for creating an illusion of a three-dimensional person. As used herein, the word “model” refers to a human or an animal by way of example.

Furthermore, there is video data sharing. For example, a first video image on the first video display device 1204 may supply video information to a second video image on the second video display device 1206, the second video image may jump from a position inside the second video display device 1206 to a position outside the first video display device 1204 displaying the first video image, or the first video image may present a character that appears in the second video image.

The video data sharing is achieved through a data file that is associated with each of the video images. The data file is read before the video images are displayed to determine a course of action. The data file may cause the video images to move from a video display device to another video display device, to be displayed on a video display device and then on another video display device, to move in synchronization with other video images, to stop at a predetermined time, or to search for a new video images to be displayed based on a preset condition.

Regardless of the source, the sequence of the animated video images is stored as an AVI file and then selected for play by selecting a desired file from a list of available files. According to an embodiment, a media player available from Provision Entertainment, the assignee of the present invention, is used to present the AVI file to the observer. The media player maps the images onto a full screen without any border or frames to maintain the illusion of the combination of two-dimensional and/or three-dimensional video images floating in space. To minimize time necessary to select and begin execution of the AVI file, a play list defining the sequential order of play of a plurality of sequences is maintained as a TXT file with individual AVI files stored as executable files.

Although the aerial image projection is of good quality, it is effective only if it is simple and more geometric in nature because of visual limitations of most observers. It has been found that very fine nuances, such as subtle blur, color change and subtle movements, in the aerial image projection, are not readily detectable. Accordingly, it is necessary to increase emphasis on the nuances when it is desirable to draw attention of the observer to a selected nuance.

Ideally, the video image is of a large article, which means that it incorporates a substantial portion of the first and the second video display devices 1204 and 1206. It has been observed that large form video images are more readily detected than small form video images because the articles appear to become visually undetectable to the observer against the dark background. Because the spherical mirror 1210 projects the picture in a proportion of at least 1:1, the projected image preferably comprises about a third of viewable number of pixels of an 800×600 pixel video display device. Thus, according to an embodiment, the minimum size of a typical article is approximately 448×338 pixels in a center of the first and the second video display devices 1204 and 1206 to ensure that the observer can detect subtle details. For larger video display devices, the number of pixels in the first and the second video display devices 1204 and 1206 may increase but the number of pixels comprising the article need not do so in like proportion. Furthermore, the number of pixels comprising the aerial image projection may not be centered when larger video display devices are used. Further still, adjusting the optical elements to magnify the video image formed on the first and the second video display devices 1204 and 1206 may decrease the number of pixels comprising the image.

As noted above, the colors of the backgrounds of the first and the second video display devices 1204 and 1206 must be dark with no red, green or blue component, that is, 0.0.0 (RGB). A switching speed is an engineering selection but the first and the second video display devices 1204 and 1206 must maintain the backgrounds as a black or dark color. Each of the video images must “appear” out the background to maintain the illusion of the combination of two-dimensional and/or three-dimensional video images. However, the video images must be bright and the colors must be saturated to maintain an observable bright line between the video images and the backgrounds. It has been observed that warm colors, such as red and orange, are bright, saturated and vivid in space. In contrast, color blue appears to fade into the background and is not an effective color because visual perception is minimized. Instead of blue, bluish green, neon green, and yellow colors are more effective and vivid. In general, regardless of the displayed color, a shiny metallic or reflective appearance regardless of the colors is more effective than dull images in the same colors. Furthermore, over-lighting the video images, such as if a bright spotlight were shining, is effective to enhance the visual perception and attract the attention of the observer.

Another problem associated with projecting the video images formed on the first and the second video display devices 1204 and 120 is optical distortion caused by the spherical mirror 1210. Accordingly, it is often necessary to modify the video images to provide necessary optical compensation so that the aerial image projection appears to be correctly proportioned. The optical compensation is added to the video images in the development environment 1104. More specifically, when the first and the second video display devices 1204 and 120 are positioned close, such as about eight (8) inches, to the beam splitter 1214, the video images displayed on the first and the second video display devices 1204 and 120 are projected further into space away from the housing 1202 but the magnified aerial image projection is distorted by the spherical mirror 1210. A solution to removing this distortion would be to position the first and the second video display devices 1204 and 120 at correct focal points. However, this limits the size of the aerial image projections to a 1:1 magnification ratio and limits a distance the aerial image projection is projected. Thus, to obtain a magnified aerial image projection far out in space, the first and the second video display devices 1204 and 120 are moved toward the beam splitter 1214 and bell-like distortion effects are compensated for in software. The software pre-distorts the video images so that when displayed, the optical distortion is exactly compensated by introducing an equal and opposite optical distortion so that the aerial image projection appears normal to the observer. As used herein, bell-like distortion means that centers of the video images are magnified more than side edges of the video images. The actual amount of pre-distortion introduced to the video images depends on the location of the first and the second video display devices 1204 and 120 and specific optical characteristics of the spherical mirror 1210.

As can be appreciated, difficulty associated with projecting the aerial image projection places a heavy burden on presentation to the observer to maintain an illusion of depth. Accordingly, certain techniques are employed to create an interesting transition from an article to another, to add text or to otherwise add interesting background visual imagery. While the set of display rules were discussed above, the set of display rules are applicable to the video images. Accordingly, additional techniques, or rules, are employed to maintain the illusion of the combination of two-dimensional and/or three-dimensional video images during the transition from the article to a different article.

Typically, the video images in foreground are in sharp clear focus while the video images in background are blurred or fuzzy. Changing the focuses of the video images in the background so that the video images become clear and sharp can be used to draw the attention of the observer to a new video image. In some situations, the video images in the foreground can then be blurred so that the observer will focus on the video images in the background. Environmental fog is effective for initially obscuring a video image until the fog clears.

The projection of existing commercials (video images captured on film) or a three-dimensional movie is visually effective when transposed from a two-dimensional format to a spatial format. The spatial format comprises the use of a rotating cube with the video images shown on faces of the rotating cube. More specifically, by using the rotating cube as the aerial image projection, a pre-existing two-dimensional commercial or promotional video footage may be converted to an aerial image projection without having to recreate a complete new animation. The rotating cube has six relatively large flat faces and the two-dimensional video footage is displayed within boundaries defined by at least one of the faces of the rotating cube. Indeed, all six faces can display the same video footage or six different video footages can be displayed simultaneously. The advantage of the floating cube is that it is easy to convert two-dimensional video footages for three-dimensional display.

The use of the spatial form to display two-dimensional video images can be combined with three-dimensional animations. The animations may include an animated person or, for example, a cyborg head.

To remove a displayed video image and replace it with another image, a transitional sequence is preferably used. The transitional sequence comprising a particulate display is used to initially obscure the image and then to hide the video image from view by the observer so that the illusion of the combination of two-dimensional and/or three-dimensional video images is maintained. Fog or explosive particulate may appear in the background and grow to envelop and eventually hide the aerial image projection. As the fog or the explosive particulate clears, a new article may be presented to the observer.

The display of floating, three-dimensional text is very effective if the font size is sufficiently large to enable easy viewing. To preserve the appearance of the floating aerial image projection, the letters must have an associated depth giving the letters a three-dimensional appearance. An effective textual display provides for the formation of words and sentences after preliminary movement in space such as if the letters were approaching the observer from a depth of space. It is also effective if the letters are given a metallic shine or appearance and materialize in space one by one. Using text in conjunction with the aerial image projection plays an important role in presenting both visual and text based information.

Photographs and or other two-dimensional video images can be projected effectively by positioning in a floating window that adds dimensional aspects to the projected video image. Background music is added to the sequence of the animated video images in the development environment 1104 in a manner that is commonly used for television commercials. Musical effects are used to emphasize three-dimensional motion and to draw the attention of the observers.

With the illusion of the combination of two-dimensional and/or three-dimensional video images that may be changed at video rates, it is also possible to combine real time video feedback with the aerial image projection. Specifically, the aerial image projection is displayed for viewing by at least one observer. A video camera 1224, referring to FIG. 2, is mounted on or located proximate to housing 124 and is coupled to the computer 1216. The video camera 1224 detects presence of the observer and combines real-time video image with the aerial image projection. In this manner, the observer becomes a part of the aerial image projection. This feature is very effective for products, such as mobile video-phones where the observer can see how they will appear to someone having a video-phone or an automobile, where the observer can be seen seated in a driver seat.

A video feed from the video camera 1224 is overlayed onto an animation layer. More specifically, the video feed is mapped onto a flat surface that is determined by four connected straight lines. More than one video feed can be mapped onto the surface so it is possible to add special effects prior to displaying the combined video feeds. The transparent imaging panel 1222 is particularly useful for incorporating additional special effects.

Referring to both FIGS. 2 and 3, if the LCD panel 1302 has a small screen size, the aerial image projection can be produced with relatively low contrast. However, as screen size increases, mechanical shields 1316 are preferably added to hide the edges of the LCD panel 1302. For example, with a 30-inch LCD panel 1302, the combination of the mechanical shields 1316 and a high contrast ratio provide an effective aerial image projection device without a visible image of the outline of the LCD panel 1302. According to an embodiment of the present invention, the contrast ratio is between 400:1 and 500:1. This contrast ratio compares to a typical contrast ratio in the range of 250:1 to 300:1 for commercially available HLCD display devices.

Further improvement is obtained by matching a size of the LCD panel 1302 to the spherical mirror 1210 and other optical elements so that the edge of the LCD panel 1302 is not projected. When displaying the aerial image projection, it is necessary to position within a region aligned with the spherical mirror 1210. Thus, by increasing the size of the LCD panel 1302 while decreasing a radius of the spherical mirror, the aerial image projection device 1200 achieves high contrast, realistic aerial image projections without a visible edge.

According to another embodiment of the present invention, a 360 degree video image of an article is generated against a blue screen. The 360 degree video image is then digitally edited to include background scenery or special effects to produce video content. Thus, a person may be digitized and then inserted into a three-dimensional animated sequence and projected as a composite aerial image projection.

A communication port 1226 is also associated with the housing 1202 and coupled to the computer 1216. The communication port 1226 may be an infrared (IR) data port that enables the observer to interact in response to the aerial image projection. By way of example, the observer may use a commercially available personal digital assistant (PDA) equipped with an IR port to download information regarding the aerial image projection. The IR port may also be used to manipulate the aerial image projection and to gather information responsive to a specific request for information from the observer. Data transfer using IR ports is well known in the art.

The communication port 1226 further comprises a speech recognition module. A preferred speech recognition module is the Philips Speech Processing product available from Speech.Philips.com. Thus, the observer may manipulate the aerial image projection using voice commands. By way of example, if the aerial image projection is an automobile, the observer may request that the passenger's door be opened and that the aerial image projection be rotated to the right by forty degrees. The observer could then request to see the automobile in a different color. In this manner, the observer is readily able to manipulate the aerial image projection in an interactive manner and to obtain information responsive to individual needs.

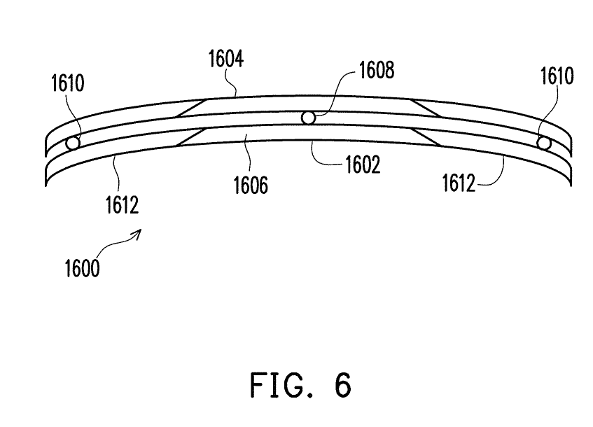

Referring now to FIG. 6, a top view of a composite plastic mirror 1600, which is equivalent to the spherical mirror 1210, is illustrated. By using the composite plastic mirror 1600, costs and weight are significantly reduced. However, to overcome limitations of plastic, the composite plastic mirror 1600 must reflect the image video images without ripple or visible optical defects. Indeed, it is commonly accepted that plastic mirrors are insufficient to produce realistic aerial images. However, the composite plastic mirror 1600 achieves necessary optical qualities and minimizes warping by maintaining a sphericity tolerance of ±0.5% from an edge of the composite plastic mirror 1600 to the other edge thereof. The sphericity tolerance compares to a sphericity tolerance of ±0.05% for glass substrate mirrors that is typically required for creating an aerial image projection of static objects.

According to an embodiment of the present invention, a sheet of mirror grade acrylic plastic, without visibly detectable chatter, is heated and placed over a mold having a spherical radius of 18.00 inches to form a desired surface of the spherical mirror 1210. It will be apparent that a larger or smaller spherical radius may be selected depending upon specific application. The sheet of mirror grade acrylic plastic may also be heated and blow molded into a mold. Alternatively, the sheet of mirror grade acrylic plastic may be injection molded to achieve desired dimensions, but injection molds are expensive and are most suitable for high volume applications. As used herein, chatter refers to an artifact of extrusion of the sheet of mirror grade acrylic plastic and is a cause of optical distortion. Thus, an extrusion process must be closely controlled to minimize introducing the chatter into the sheet of mirror grade acrylic plastic because it is critical to begin the molding process with optical quality acrylic. Minimizing surface defects caused by dust or other debris is also critical for minimizing optical distortion. Accordingly, the molding process is preferably conducted in a clean room environment and both the sheet of mirror grade acrylic plastic and the mold are cleaned before molding occurs.

After cleaning, the mold is coated with a release agent and the sheet of mirror grade acrylic plastic is then molded and coated with a removable protective covering. Once molded, both surfaces of the mold and the sheet of mirror grade acrylic plastic are further treated to minimize surface defects. The composite plastic mirror 1600 must have a surface quality of 80-50 scratch/dig where scratch/dig is a common measure of surface defects.

The composite plastic mirror 1600 is a composite mirror comprising a front substrate 1602 and a rear substrate 1604. Both the front and the rear substrates 1602 and 1604 are preferably a quarter inch thick sheet of acrylic plastic cut to necessary dimensions. The backside 1606 of the front substrate 1602 is coated with aluminum. The coating may be applied using a vacuum deposition process to provide a mirror-like finish.

The rear substrate 1604 need not include the coating of aluminum as a purpose of the rear substrate 1604 is to provide structural support for the front substrate 1062 and to minimize warping due to the different thermal coefficient of expansion of acrylic and aluminum. The rear substrate 1604 is laminated to the front substrate 1602 after it is aluminized. To minimize stress, epoxy or other bonding agents is applied to selected areas of a surface 1606. By way of example, epoxy regions 1610 are each proximate to a corner of the front and the rear substrates 1602 and 1604. An epoxy region 1608 is proximate to centers of the front and the rear substrates 1602 and 1604. It will be appreciated that additional epoxy regions may be required for large dimensional mirrors. The epoxy should have low thermal conductivity to insulate the front substrate 1602 from the rear substrate 1604. The preferred epoxy is RTV-108 silicon adhesive although other adhesives, such as Bondo, may be used. A suitable mounting bracket (not shown) may be attached to a back of the substrate 1604 for attachment to the housing 1202.

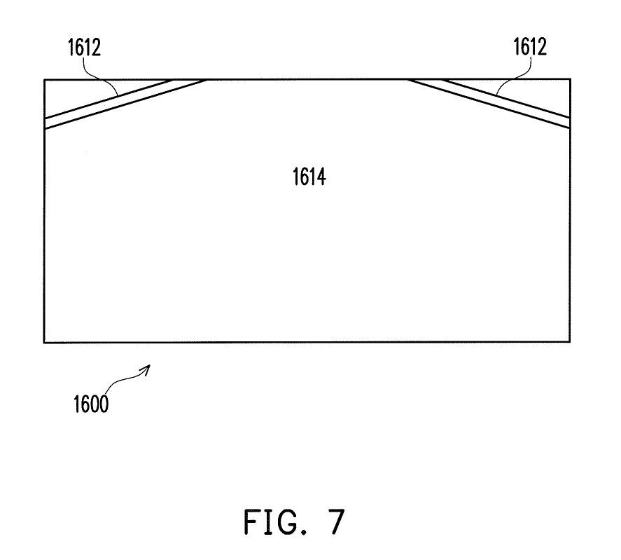

Referring now to FIG. 7, a front view of the composite plastic mirror 1600 is shown. When light is directed toward a front face 1614 of the composite plastic mirror 1600, the surface 1606 will reflect it. As shown, the upper corners of the composite plastic mirror 1600 are beveled as indicated at 1612 to minimize the footprint and enable the housing to be smaller.

In view of the above description, it should be apparent that the present invention may be mass produced at low cost and may be readily incorporated into most applications from use as a display for use with a desktop computer to provide customer service functions at checkout counters or service kiosks.

While certain exemplary preferred embodiments have been described and shown in the accompanying drawings, it is to be understood that such embodiments are merely illustrative of and not restrictive on the broad invention. Further, it is to be understood that this invention shall not be limited to the specific construction and arrangements shown and described since various modifications or changes may occur to those of ordinary skill in the art without departing from the spirit and scope of the invention as claimed.

What is claimed is:

1. An aerial image projection device comprising
a housing;
a first video display device mounted in the housing for generating a two-dimensional or three-dimensional video image, the first video display device comprising a display panel having a plurality of individually controllable first pixels with low transmissivity between each of the first pixels and a first backlight for generating light to form an aerial image projection;
a second video display device mounted in the housing for generating another two-dimensional or three-dimensional video image, the second video display device comprising another display panel having a plurality of individually controllable second pixels with low transmissivity between each of the second pixels and a second backlight for generating light to form another aerial image projection;
controller means for controlling both the video display devices to achieve a background color of zero red, zero green and zero blue when forming a video image on a portion of each of the video display panels;
a beam splitter mounted in the housing in optical alignment with both the video display devices,
a spherical mirror mounted in the housing in optical alignment with the beam splitter such that portions of the light from both the video display devices are directed to the spherical mirror; and
a polarizer, mounted in the housing in optical alignment with the beam splitter so that the portions of the light are transmitted out of said housing to form the aerial image projections.

2. The aerial image projection device of claim 1 wherein the polarizer and the beam splitter are combined into one part.

3. The aerial image projection device of claim 1 wherein the first video display device and the second video display device have a 20 degree viewing angle to reduce light loss, heat generation and power consumption and allow for a brighter image.

4. The aerial image projection device of claim 1 wherein angles between the polarizer and the first video display device and the second video display device are adjusted to reduce light loss when light passes through the polarizer.

5. The aerial image projection device of claim 1 wherein the polarizer further comprises an antireflective coating on a surface of the polarizer facing away from the beam splitter.

6. The aerial image projection device of claim 1 further comprising a transparent imaging panel proximate to the third portion of the housing, the transparent imaging panel controllable for displaying video information, a portion of the transparent imaging panel adapted for passing the aerial image projections from the housing into a region of space beyond the imaging device.

7. The aerial image projection device of claim 1 wherein each of the first backlight and the second backlight comprises a full spectrum light source generating at least 3,600 Lumens.

8. The aerial image projection device of claim 1 further comprising a first frame and a second frame, respectively surrounding an edge portion of each of the first display panel and the second display panel to minimize visibility of the first display panel and the second display panel to an observer of the aerial image projections.

9. The aerial image projection device of claim 1, wherein each of the first video display device and the second video display device further comprises:
a prism for collecting off-axis light from the backlight and re-directing the off-axis light through the display panel;
means for filtering high frequency components of the light; means for collimating the light exiting the display panel; and
a polarizer having a layer of anti-reflective coating on a surface oriented away from the display panel.

10. The aerial image projection device of claim 1 wherein each of the first backlight and the second backlight comprises a light source generating at least 3,600 Lumens.

11. The aerial image projection device of claim 10 further comprising two light shields, respectively surrounding the edge portion of each of the first display panel and the second display panel and having a contrast ratio of at least 400:1.

12. The aerial image projection device of claim 11 wherein each of the first video display device and the second video display device further comprises a high bright superblack LCD having a narrow field of view to reduce disbursement of off-axis light and to substantially focus the light in a forward direction.

13. The aerial image projection device of claim 12 wherein dimensions of each of the high bright superblack LCDs are proportional to dimensions of the spherical mirror.

14. The aerial image projection device of claim 1 wherein each of the first video display device and the second video display device further comprises:
a display panel having a plurality of individually controllable pixels;
a controller for maintaining selective pixels of the plurality of pixels at a superblack state; and
a light source generating at least 3,600 Lumens.

15. The aerial image projection device of claim 14 wherein the superblack state comprise at least twenty darkest dark shades achievable by the display panels.

16. The aerial image projection device of claim 14 wherein the superblack state comprise at least darkest two percent (2%) of dark shades achievable by the display panels.

17. The aerial image projection device of claim 1 wherein the housing further comprises:
a lightweight tubular frame, comprising a plurality of cross-members for mounting the beam splitter and the spherical mirror in optical alignment with the first video display device and the second video display device; and
a facade attached to the frame for shielding an interior of the housing from external ambient light sources.

18. The aerial image projection device of claim 17 further comprising a transparent imaging panel coupled to the lightweight tubular frame so that the transparent imaging panel is in optical alignment with the beam splitter and the spherical mirror, the transparent imaging device being controllable for displaying video information.

19. A method for projecting an aerial image projection comprising:
providing two video display devices, each of the video display devices having a superblack background;
controlling each of the video display devices to form a video image on a portion of each of the video display devices while maintaining the superblack backgrounds;
providing two backlights of sufficient intensity to generate aerial image projections visible in ambient light from the images; and
projecting the video images through optical paths to form the aerial image projections.

20. The method of claim 19 further comprising data sharing, the data sharing being achieved through a data file that is associated with each of the video images, wherein the data file is read before the video images are displayed to determine a course of action.

21. The method of claim 19 further comprising a step of transferring the video images from a server computer to the video display devices prior to the step of controlling each of the video display devices.

22. The method of claim 19 further comprising a step of projecting a sequence of the video images at video rate.

23. The method of claim 22 further comprising:
maintaining background colors surrounding the video images as superblack; and
preventing movements of the video images beyond edges of the video display devices.

24. The method of claim 19 further comprising combining the aerial image projections with separately generated video images so that the aerial image projections and the separately generated video images are simultaneously observable.

25. The method of claim 19 further comprising combining the video images with separately generated video images so that the video images and the separately generated video images form composite aerial image projections.

26. The method of claim 19 further comprising:
providing a development environment for developing a sequence of animated video images; and
transferring the sequence of the animated video images from the development environment to the video display devices prior to the step of controlling each of the video display devices.

27. The method of claim 26 wherein the step of projecting the images further comprises:
projecting the sequence of the animated video images through a transparent imaging panel; and
independently generating another video image on the transparent imaging panel.

28. The method of claim 26 further comprising:
in the development environment, compensating the video images for optical distortion associated with the step of projecting the video images.

29. The method of claim 26 further comprising:
in the development environment, selecting a color scheme to achieve an illusion of a realistic aerial image projection that is a combination of two-dimensional and/or three-dimensional video images.

30. The method of claim 29 wherein the color scheme is selected from a palette comprising red, yellow, blue-green and green colors.

31. The method of claim 30 wherein the palette further comprises metallic shine and neon colors.

32. The method of claim 26 further comprising developing the sequence of the animated video images in accordance with a set of display rules.

33. The method of claim 26 further comprising adding background music to the sequence of the animated video images in the development environment.

34. The method of claim 26 further comprising using a transitional sequence to hide a part of the video images from view during a beginning or an end of the sequence of the animated video images to maintain an illusion of a realistic aerial image projection that is a combination of two-dimensional and/or three-dimensional video images.

35. The method of claim 26 further comprising transposing a two-dimensional format to a spatial format.

36. A computer to implement the method of claim 26.

37. A computer-readable medium having instructions for assisting in implementation of the method of claim 26.

38. A system to implement the method of claim 26.

39. The method of claim 19 further comprising selecting an image color scheme to achieve high contrast relative to the superblack backgrounds.

40. A computer to implement the method of claim 19.

41. A computer-readable medium having instructions for assisting in implementation of the method of claim 19.

42. A system to implement the method of claim 19.

43. An aerial image projection device comprising:
a housing;
a beam splitter coupled to the housing;
a spherical mirror coupled to the housing and optically aligned with the beam splitter along a first axis;
two high bright superblack LCDs mounted in the housing for projecting aerial image projections having visual appearance of a combination of two-dimensional and/or three-dimensional video images onto the beam splitter along a second axis perpendicular to the first axis; and
means for minimizing glare and reflection from a surface of the beam splitter facing away from the spherical mirror.

44. The aerial image projection device of claim 43 wherein the polarizer and the beam splitter are combined into one part.

45. The aerial image projection device of claim 43 wherein the first video display device and the second video display device have a 20 degree viewing angle to reduce light loss, heat generation and power consumption and allow for a brighter image.

46. The aerial image projection device of claim 43 wherein angles between the polarizer and the first video display device and the second video display device are adjusted to reduce light loss when light passes through the polarizer.

47. The aerial image projection device of claim 43 wherein the means for minimizing glare and reflection comprises using a polarizer.

48. The aerial image projection device of claim 47 further comprising an antireflective coating on a surface of the polarizer facing away from the beam splitter.

49. The aerial image projection device of claim 47 further comprising a transparent imaging panel for displaying video information in combination with the video images.

50. The aerial image projection device of claim 43 further comprising a communication port.

51. The aerial image projection device of claim 43 further comprising frames surrounding edge portions of the high bright superblack LCDs.

52. The aerial image projection device of claim 43 wherein a material of the beam splitter is a plastic substrate.

53. The aerial image projection device of claim 43 wherein the spherical mirror comprises a composite plastic mirror having a first plastic spherical mirror supported by a complementary second plastic spherical sheet.

54. The aerial image projection device of claim 53 wherein the first spherical mirror is a molded sheet of optically clear acrylic.

55. The aerial image projection device of claim 53 wherein the first spherical mirror comprises a reflecting layer on a backside thereof.

56. The aerial image projection device of claim 53 wherein the first spherical mirror is coupled to the second plastic spherical sheet by epoxy.

57. The aerial image projection device of claim 43 wherein the means for minimizing glare and reflection comprises using a linear polarizer.

58. The aerial image projection device of claim 43 wherein the means for minimizing glare and reflection comprises using a circular polarizer.
